(19) United States
(12) Patent Application Publication
(10) Pub. No.: US 2025/0116764 A1
(43) Pub. Date: Apr. 10, 2025

(54) HETERODYNE DEPTH SENSOR

(71) Applicant: STMicroelectronics International N.V., Geneva (CH)

(72) Inventor: Pascal Mellot, Lans en Vercors (FR)

(21) Appl. No.: 18/783,160

(22) Filed: Jul. 24, 2024

(30) Foreign Application Priority Data
Aug. 8, 2023 (FR) 2308564

(51) Int. Cl. G01S 7/4912; G01S 7/4914; G01S 7/4915; G01S 17/89

(52) U.S. Cl. CPC G01S 7/4917; G01S 7/4914; G01S 7/4915; G01S 17/89

(57) ABSTRACT

An example heterodyne sensor of the present disclosure includes one or more optical mixers and an array of pixels. The optical mixers are configured to combine a reference light beam with one or more return light beams in order to generate one or more beat signals. Each pixel of the array of pixels includes a single-photon avalanche diode configured to receive a corresponding one of the one or more beat signals and to generate an output signal as a function of a light intensity of a received beat signal, and a digital counter configured to generate a count value based on the output signal of the single-photon avalanche diode.

### CROSS-REFERENCE TO RELATED APPLICATIONS

This application claims priority to French Application No. 2308564, filed on Aug. 8, 2023, which application is hereby incorporated herein by reference.

### TECHNICAL FIELD

The present disclosure relates generally to the field of depth sensors, and in particular to the field of heterodyne depth sensors.

### BACKGROUND

One type of heterodyne sensor is a frequency-modulated continuous wave (FMCW) active imaging system, also known as a FMCW lidar. In such a system, the light source is a coherent source, for example a laser source, emitting a frequency-modulated radiation having frequency that varies according to a periodic linear ramp. The radiation emitted by the source is divided into a reference beam and a transmission beam. The transmission beam is projected onto the scene where it is reflected by an object towards the optical mixer of the sensor, whereas the reference beam is sent to an optical mixer of the image sensor without passing through the scene. The reference beam and the transmission beam interfere with each other at the optical mixer of the image sensor, resulting in a beat signal having a frequency representative of the time delay between the two beams, which is proportional to twice the distance between the image sensor and the object, thereby enabling the depth of the object in the scene to be determined.

In order to capture a depth image based on FMCW, an array of imaging pixels is for example used to detect the amplitude of the return signal from the scene. However, there are technical difficulties in providing an image sensor suitable for FMCM imaging and having an acceptable resolution, precision, power consumption and area.

### SUMMARY

According to one aspect, there is provided a heterodyne sensor comprising: one or more optical mixers configured to combine a reference light beam with one or more return light beams in order to generate one or more beat signals; and an array of pixels, each pixel comprising: a single-photon avalanche diode configured to receive a corresponding one of the one or more beat signals and to generate an output signal as a function of the light intensity of the received beat signal; and a digital counter configured to generate a count value based on the output signal of the single-photon avalanche diode.

According to one embodiment, the array comprises pixels arranged in rows and columns, the heterodyne sensor comprising a sequencer configured to operate the pixels of the array in a rolling shutter operation wherein the counters of the pixels of each row of the array are read during a corresponding read phase that is offset with respect to the read phases of the counters of the pixels of the other rows of the array.

According to one embodiment, the heterodyne sensor further comprises one or more optical elements covering the array and configured to direct the return light beam to the one or more optical mixers.

According to one embodiment, a sampling frequency of the counter of each pixel is of less than 500 kHz, and preferably of less than 100 kHz.

According to one embodiment, the one or more optical mixers is a single element covering the pixel array.

According to a further aspect, there is provided a heterodyne imaging system comprising: the above heterodyne sensor; modulation circuit configured to generate a ramp signal for modulating a coherent light source in order to generate a modulated light beam; an optical splitter configured to split the modulated light beam into said reference light beam and a transmission light beam; and an illumination optical system configured to illuminate a field of view of the heterodyne sensor with the transmission beam.

According to one embodiment, the heterodyne imaging system further comprises a memory for storing a succession of images generated by the heterodyne sensor, and a post-processing circuit configured to perform a Fourier transform operation on the pixel values captured by each pixel in the succession of images in order to evaluate a frequency variation captured by each pixel, and thereby generate a depth value per pixel.

According to a further aspect, there is provided a method of capturing a depth image based on a heterodyne sensor, the method comprising: combining, by one or more optical mixers, a reference light beam and one or more return light beams in order to generate one or more beat signals; generating, by a single-photon avalanche diode of each pixel of a pixel array of the heterodyne sensor, an output signal as a function of the light intensity of a corresponding one of the one or more beat signals; and generating, by a digital counter of each pixel, a count value based on the output signal of the single-photon avalanche diode.

According to one embodiment, the array comprises pixels arranged in rows and columns, the method further comprising operating, by a sequencer of the heterodyne sensor, the pixels of the array in a rolling shutter operation wherein the counters of the pixels of each row of the array are read during a corresponding read phase that is offset with respect to the read phases of the counters of the pixels of the other rows of the array.

According to one embodiment, a sampling frequency of the counter of each pixel is of less than 500 kHz, and preferable of less than 100 kHz.

According to one embodiment, the method further comprises: generating, by a modulation circuit, a ramp signal for modulating a coherent light source in order to generate a modulated light beam; splitting, by an optical splitter, the modulated light beam into said reference light beam and a transmission light beam; and illuminating, by an illumination optical system, a field of view of the heterodyne sensor with the transmission beam.

According to one embodiment, the method further comprises: storing to a memory a succession of images generated by the heterodyne sensor; and performing, by a post-processing circuit, a Fourier transform operation on the pixel values captured by each pixel in the succession of images in order to evaluate a frequency variation captured by each pixel, and thereby generate a depth value per pixel.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 schematically illustrates an FMCW sensor according to an example embodiment;

FIG. 2 is a graph representing the frequency of emitted and received ramp signals over time according to an example embodiment;

FIG. 3 is a graph representing, in the frequency domain, a detected frequency difference between the emitted and received ramp signals according to an example embodiment;

FIG. 4 schematically illustrates an FMCW imaging system according to an example embodiment of the present disclosure;

FIG. 5 schematically illustrates a heterodyne imager of the FMCW imaging system of FIG. 4 in more detail according to an example embodiment of the present disclosure;

FIG. 6 schematically represents a cross-section of the heterodyne imager of FIG. 5 according to an example embodiment of the present disclosure; and

FIG. 7 is a timing diagram illustrating a rolling-shutter operation of the heterodyne imager of FIG. 5 according to an example embodiment of the present disclosure.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. For example, optical mixers for combining two light signals of having different modulated frequencies in order to generate a beat signal are known in the art, and will not be described in detail herein.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

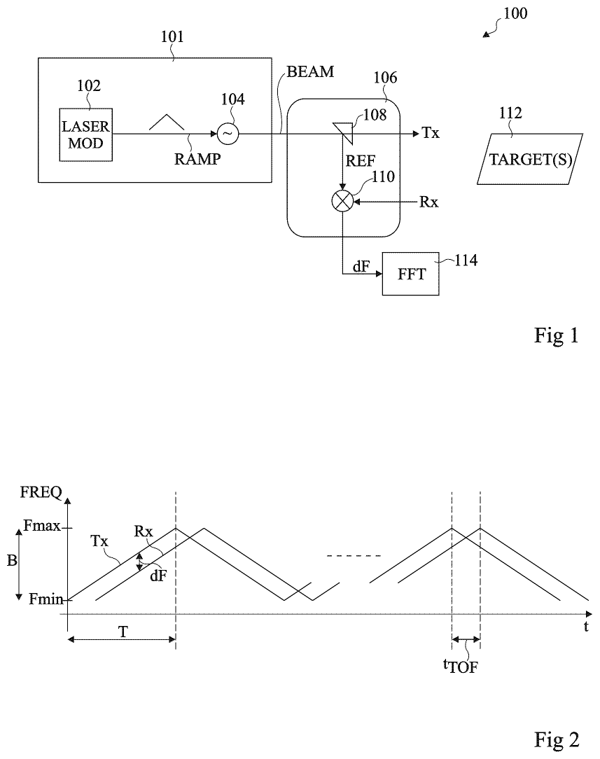

FIG. 1 schematically illustrates an FMCW sensor 100 according to an example embodiment.

The sensor 100 of FIG. 1 comprises a coherent modulated light source 101, adapted to emitting a coherent light beam BEAM. Light source 101 for example comprises an FMCW laser modulator (LASER MOD) 102 configured to generate to a ramp signal RAMP, for example in the form of a voltage or current, and to supply the ramp signal to an emission source 104. In some embodiments, the emission source 104 is implemented by a controlled oscillator configured to modulate the frequency of the beam BEAM based on the ramp signal RAMP. Alternatively, the emission source 104 is for example a source, such as a VCSEL (Vertical Cavity Surface-Emitting Laser), having a natural wavelength that is naturally modulated by a current intensity of the ramp signal, thereby creating the frequency modulation without the need for a controlled oscillator. The emission source 104 is for example a laser source, and is for example configured to emit light in the infrared spectrum. The optical frequency of light source 104 is modulated according to a predefined law, for example, a continuous law, for example, a periodic linear law. The optical frequency of source 104 varies over time according to said predefined law.

The sensor 100 of FIG. 1 further comprises an optical module 106 comprising, for example, an optical splitter 108 adapted to divide the light beam BEAM into a transmission beam Tx that is transmitted into the scene, and a reference beam REF, which is supplied to an optical mixer 110. The transmission beam Tx is reflected by one or more target objects (TARGET(S)) in the scene at a given distance(s) from the sensor 100, and the reflected beam forms a return beam Rx to the optical module 106. The return beam Rx is combined with the reference beam REF, for example by spatially superposing one beam on the other, in order to generate a heterodyne beam dF, corresponding to a beat signal having a frequency, or a plurality of frequency components, equal to a frequency difference between the transmission and return beams Tx, Rx.

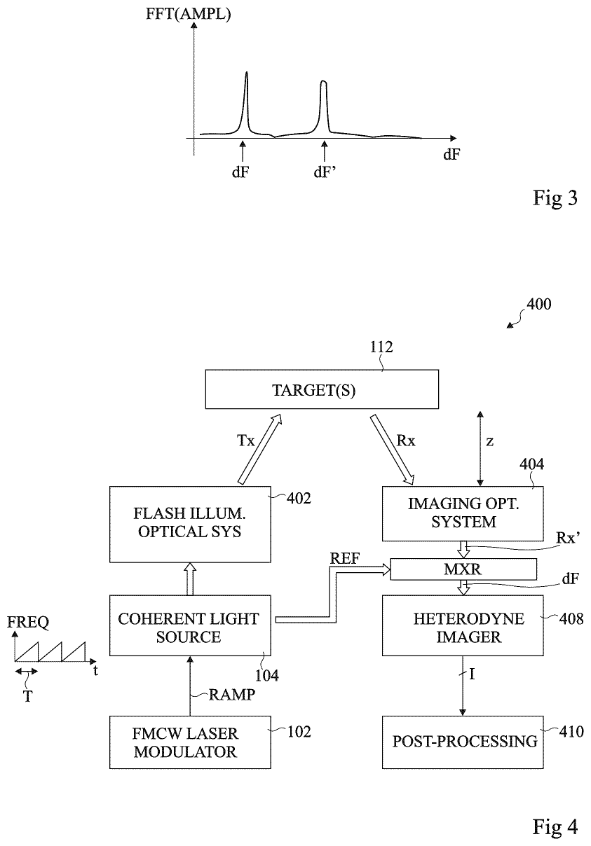

The sensor 100 further comprises a conversion circuit (FFT) 114, for example comprising a Fourier transform function, such as a fast Fourier transform function (FFT), is configured to sample the heterodyne beam dF in order to determine one or more frequencies, that represent one or more distances of target objects in the scene, as will be explained in more detail with reference to FIGS. 2 and 3.

FIG. 2 is a graph representing, the frequency variations (FREQ) of the ramps of the transmission beam Tx and return beam Rx over time (t) according to an example embodiment. FIG. 2 is based on an example in which the ramp signal RAMP has a triangle waveform, and has a frequency range B from a minimum frequency Fmin to a maximum frequency Fmax, and a rising sweep duration, i.e. from Fmin to Fmax, of T. The falling sweep duration, i.e. from Fmax to Fmin, is for example equal to the rising sweep duration. The return beam Rx has a similar waveform to the transmission beam Tx, but is delayed by a time delay t_{TOF} with respect to the transmission beam Tx. This time delay corresponds to the time it takes for the transmission beam Tx to reach the target object and then return to the sensor, and is thus proportional to twice the distance between the sensor and the target.

FIG. 3 is a graph representing, in the frequency domain, the result of a fast Fourier transform (FFT AMPL) applied to the amplitude of the heterodyne beam. As represented, there is a peak at the frequency dF corresponding to the frequency difference between the reference beam REF and the return beam Rx reflected from a first target object in the scene. FIG. 3 also illustrates a further peak at a frequency dF′ corresponding to the frequency difference between the reference beam REF and a further frequency component of the return beam Rx in the case that there is a second target object in the scene at a greater distance than the first target object.

The distance d to an object can be calculated using the following equation:

$$d = \frac{{c}^{′} \cdot {t}_{T O F}}{2} \qquad [ Math 1 ]$$

where c′ is the speed of light in air. The time t_{TOF} can be obtained by the following equation:

$${t}_{T O F} = \frac{T \cdot dF}{B} \qquad [ Math 2 ]$$

where T is the time to complete the frequency sweep, B is the frequency range of the frequency sweep.

According to one example, the wavelength λ of the light source varies in between 940.000 nm to 940.003 nm, meaning that Fmin=319.14554 THz, Fmax=319.14954 THz and B=4 GHz. Furthermore, the rising sweep duration T is for example equal to 10 ms, and the maximum distance Dmax that can be detected is for example equal to 9.6 m. Therefore, it is possible to define the following parameters: the minimum distance Dmin that can be detected is equal to c/2B=3.75 cm; the FFT granularity for 1 bin=1/T=100 Hz; the data sampling frequency

$$F s > 2 \cdot \frac{D max}{D min} \cdot T \to F s \geq 25.6 Hz ;$$

the FFT output number of points

$$Npoints = 2 \cdot D max \cdot \frac{B}{c} = 256 .$$

More generally, Fmin is for example equal to at least 1 THz, B is equal to at least 100 MHz, Dmax is equal to at least 2 m, and T is equal to at least 1 ms.

FIG. 4 schematically illustrates an FMCW imaging system 400 according to an example embodiment of the present disclosure. Certain features of the system 400 of FIG. 4 are the same as in the sensor 100 of FIG. 1, and these elements have been labelled with like reference numerals and will not be described again in detail. In particular, the principles of FMCW imaging as described in relation with FIG. 1 are implemented in the system of 400.

The system 400 comprises an FMCM laser modulator (FMCW LASER MODULATOR) 102 similar to the one of FIG. 1 configured to generate a ramp signal RAMP, and a coherent light source (COHERENT LIGHT SOURCE) 104 similar to the one of FIG. 1. In the example of FIG. 4, the FMCW laser modulator 102 is configured to generate a ramp signal having a sawtooth waveform. In alternative embodiments, rather than a sawtooth waveform, a triangular waveform, or other waveform including a rising and/or falling ramp, could be used.

The beam generated by the light source 104 is supplied to the reception side of the system as a reference beam, and is transmitted into the scene as a transmission beam Tx. For example, while not illustrated in FIG. 4, the modulated output beam generated by the coherent light source 104 is split using an optical splitter similar to the splitter 108 of FIG. 1 in order to generate the reference and transmission beams REF, Tx.

In the example of FIG. 4, the system 400 further comprises a flash illumination optical system (FLASH ILLUM. OPTICAL SYS) 402 configured to illuminate an entire field of view of the imaging system 400 at the same time with the transmission beam Tx. For example, the optical system 402 comprises optical components such as diffusers and/or lenses.

Like in FIG. 1, the scene comprises one or more targets (TARGET(S)) 112 at a distance z from the imaging system.

The return beam Rx from the scene is for example received via an imaging optical system (IMAGING OPT. SYSTEM) 404, an optical mixer (MXR) 406, and a heterodyne imager (HETERODYNE IMAGER) 408 of the imaging system 400. The heterodyne imager 408 for example comprises an array of pixels P_{x,y}.

The imaging optical system 404 is for example formed of one or more lenses configured to direct the return beam towards the optical mixer 406 and heterodyne imager 408. For example, the imaging optical system 404 comprises a single lens covering the field of view of the system. In alternative embodiments, the one or more lenses could comprise discrete lenses, one per pixel of the heterodyne imager.

The beam Rx′ generated by the one or more lenses of the imaging optical system 404 is for example provided via the optical mixer MXR to each pixel P_{x,y} of the heterodyne imager 408. The optical mixer MXR is for example a single element that covers the array, and is configured to combine the common reference beam REF with the received beam transmitted by the one or more lenses of the imaging optical signal and to provide the resulting beat signal dF to the pixels P_{x,y} of the heterodyne imager 408. In alternative embodiments, the optical mixer is pixel-based, in other words an optical mixer element MXR_{x,y} is provided for each pixel, each element receiving the reference beam REF, and combining it with the received beam to generate the corresponding beat signal dF_{x,y}.

The heterodyne imager 408 is for example configured to sample a light intensity of the beat signal dF received by each pixel, and to provide the sampled signals as digital intensity images I to a post-processing circuit (POST-PROCESSING) 410. The circuit 410 is for example configured to perform a Fourier transform, such as an FFT operation, on the pixel values captured by each pixel P_{x,y} in the succession of images I in order to evaluate the frequency variation dF captured by each pixel, and thereby generate a depth value (z_{x,y}) per pixel. The circuit 410 is for example implemented in hardware, for example by an ASIC (application specific integrated circuit). Alternatively, the functions of the circuit 410 could at least partially be implemented by software executed by one or more processors of the circuit 410.

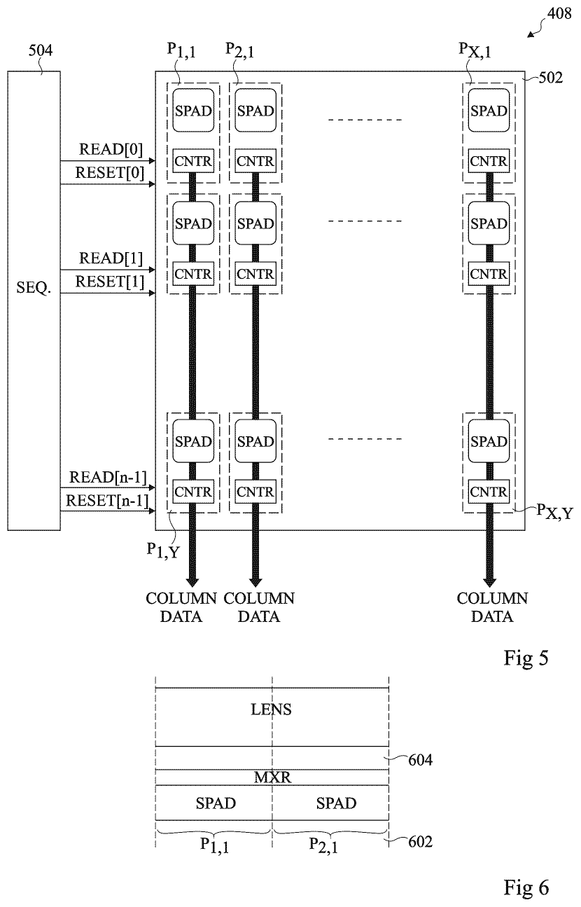

FIG. 5 schematically illustrates the heterodyne imager 408 of the FMCW imaging system 400 of FIG. 4 in more detail according to an example embodiment of the present disclosure. The imager 408 comprises a pixel array 502 of size X by Y, in other words there being pixels P_{1,1} to P_{X,1} in a first row, and pixels P_{1,Y} to P_{X,Y} in a last row.

Each pixel P_{x,y} of the array 502 for example comprises a single-photon avalanche diode detector (SPAD) and a counter (CNTR). As known by those skilled in the art, a SPAD detector is configured to generate an event, such as a voltage transition or pulse, each time the arrival of a photon is detected. According to the embodiments described herein, the events are accumulated locally by the counter CNTR within each pixel. Each counter CNTR is for example reset by a reset signal RESET, and read by a read signal READ. For example, the reset and read signals applied to each counter have a frequency equal to the sampling frequency Fs of the imager. The sampling frequency Fs is for example equal to twice the maximum frequency of the signal dF to be detected. According to one embodiment, for a maximum detection frequency of 25.6 kHz, the sampling frequency Fs is 51.2 kHz.

The example imager 408 of FIG. 5 is based on rolling shutter operation in which the rows are each controlled individually by read and reset signals generated by a sequencer (SEQ.) 504. For example, assuming the array has n rows from 0 to (n−1), the counters CNTR of a first row 0 of the array are each controlled by a common read signal READ[0] and a common reset signal RESET[0], and the counters CNTR of a last row of the array are each controlled by a common read signal READ[n−1] and a common reset signal RESET[n−1].

The counters CNTR in each column of pixels are for example configured to provide output data in a common column data bus COLUMN DATA, this column data forming the digital images I that are for example stored to a memory (not illustrated in FIG. 5) and processed by the post-processing circuit 410.

FIG. 6 schematically represents a cross-section of a portion of the heterodyne imager of FIG. 5 according to an example embodiment of the present disclosure. The cross-section of FIG. 6 illustrates in particular the pixels P_{1,1} and P_{2,1} of FIG. 5, but it will be understood that each of the pixels on the array 502 for example has a similar structure. As illustrated, each pixel for example comprises a stack formed in and on a substrate 602, the stack comprising a SPAD detector (SPAD), an optical mixer (MXR), which can be a common element for the entire array or a pixel-based element, covering the SPAD detector, a separation layer 604, for example formed of a transparent material such as oxide (not drawn to scale), and an optical element (LENS) formed over the separation layer 604, the optical element for example being a single lens covering the entire array.

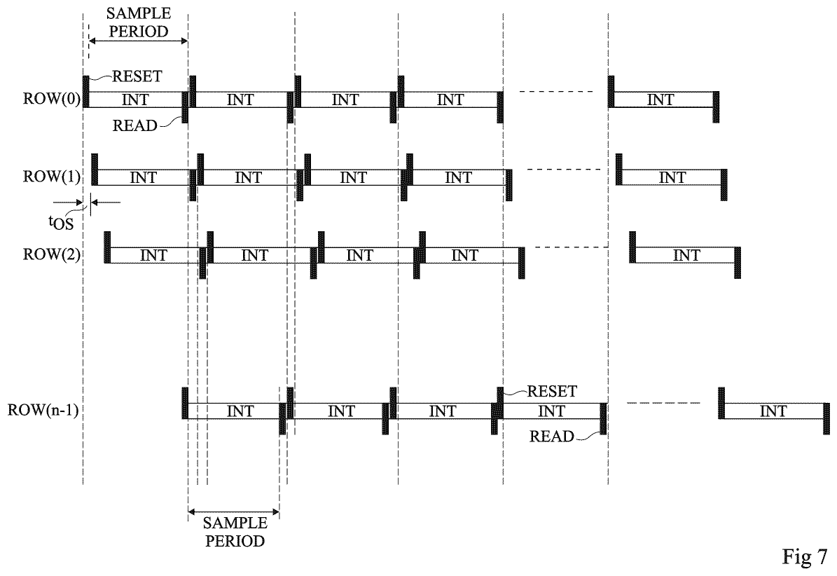

FIG. 7 is a timing diagram illustrating a rolling-shutter operation of the heterodyne imager of FIG. 5 according to an example embodiment of the present disclosure.

As illustrated, the example of FIG. 7 is based on a rolling shutter operation in which the n rows ROW(0) to ROW(n−1) of the array are controlled individually. The digital counter CNTR of each pixel of a row is reset by the corresponding reset signal RESET before an integration period (INT) of the row, and is read by the corresponding read signal READ at the end of integration period (INT) of the row. A sample period (SAMPLE PERIOD) extends from the end of the reset phase of a counter to the start of a subsequent reset phase of the counter. Within a sample period, the n rows of the array are for example read. Thus, the sampling periods between one row and the next are for example offset by a time delay tₒₛ equal to the sample period divided by n. Thus, the sequencer 504 is configured to operate the pixels of the array in a rolling shutter operation according to which the counters CNTR of the pixels of each row of the array are read during a corresponding read phase that is offset with respect to the read phases of the counters of the pixels of the other rows of the array.

A sequence of m sample periods is for example executed in order to determine, for each pixel, one or more depth readings. In some embodiments, m is equal to at least 10, and preferable to at least 100.

An advantage of the embodiments described herein is that depth images having a relatively high resolution can be captured by a heterodyne imager operating at a relatively low sampling frequency, for example of less than 500 kHz, and preferably of less than 100 kHz. For example, the pixel array may comprise 64 or more pixels, arranged for example in 8 or more rows and 8 or more columns, and preferably at least 500 pixels arranged in two or more rows and two or more columns.

Furthermore, an advantage of the rolling shutter operation as described in relation with FIG. 7 is that the rise time T of the ramp signal can be substantially equal to the full frame period, leading to a high signal to noise ratio (SNR), and also relaxing constraints on the sampling frequency.

An advantage of using a SPAD detector as the photodetector in each pixel of the heterodyne imager is that such a device has a relative fast response time, and is compatible with driving a local digital counter in order to locally store an intensity measure at each pixel. Thus, the SPAD-based detection allows a digital conversion to be performed directly in the pixel at relatively low power and area.

Various embodiments and variants have been described. Those skilled in the art will understand that certain features of these embodiments can be combined and other variants will readily occur to those skilled in the art. For example, while embodiments are described in which each pixel of an array comprises a single SPAD, it would be possible for each pixel to comprise a plurality of SPADs.

Finally, the practical implementation of the embodiments and variants described herein is within the capabilities of those skilled in the art based on the functional description provided hereinabove.

What is claimed is:

1. A heterodyne sensor comprising:
one or more optical mixers configured to combine a reference light beam with one or more return light beams in order to generate one or more beat signals; and
an array of pixels, each pixel comprising:
a single-photon avalanche diode configured to receive a corresponding one of the one or more beat signals and to generate an output signal as a function of a light intensity of a received beat signal, and
a digital counter configured to generate a count value based on the output signal of the single-photon avalanche diode.

2. The heterodyne sensor of claim 1, wherein the array comprises pixels is arranged in rows and columns, the heterodyne sensor comprising a sequencer configured to operate the pixels of the array in a rolling shutter operation, wherein the counters of the pixels of each row of the array are read during a corresponding read phase that is offset with respect to the read phases of the counters of the pixels of the other rows of the array.

3. The heterodyne sensor of claim 2, wherein the rolling shutter operation comprises:
resetting the digital counter of each pixel in a row before an integration period;
reading the digital counter of each pixel in the row at the end of the integration period; and
offsetting the integration periods of adjacent rows by a time delay equal to a sample period divided by a total number of rows in the array.

4. The heterodyne sensor of claim 1, further comprising one or more optical elements covering the array and configured to direct the return light beam to the one or more optical mixers.

5. The heterodyne sensor of claim 1, wherein a sampling frequency of the counter of each pixel is of less than 500 kHz, and preferably of less than 100 kHz.

6. The heterodyne sensor of claim 1, wherein the one or more optical mixers is a single element covering the array of pixels.

7. The heterodyne sensor of claim 1, wherein each pixel comprises a stack formed on a substrate, the stack comprising:
the single-photon avalanche diode;
an optical mixer covering the single-photon avalanche diode;
a separation layer comprising a transparent oxide material and disposed over the optical mixer; and
a lens disposed over the separation layer.

8. The heterodyne sensor of claim 1, wherein the one or more optical mixers is a single element covering all of the array of pixels.

9. A heterodyne imaging system comprising:
a heterodyne sensor comprising:
one or more optical mixers configured to combine a reference light beam with one or more return light beams in order to generate one or more beat signals; and
an array of pixels, each pixel comprising:
a single-photon avalanche diode configured to receive a corresponding one of the one or more beat signals and to generate an output signal as a function of a light intensity of a received beat signal, and
a digital counter configured to generate a count value based on the output signal of the single-photon avalanche diode;
a modulation circuit configured to generate a ramp signal for modulating a coherent light source in order to generate a modulated light beam;
an optical splitter configured to split the modulated light beam into the reference light beam and a transmission light beam; and
an illumination optical system configured to illuminate a field of view of the heterodyne sensor with the transmission light beam.

10. The heterodyne imaging system of claim 9, further comprising a memory for storing a succession of images generated by the heterodyne sensor, and a post-processing circuit configured to perform a Fourier transform operation on the pixel values captured by each pixel in the succession of images in order to evaluate a frequency variation captured by each pixel, and thereby generate a depth value per pixel.

11. The heterodyne imaging system of claim 9, wherein the ramp signal has a sawtooth waveform.

12. The heterodyne imaging system of claim 9, wherein the coherent light source is configured to emit light with a wavelength that varies between 940.000 nm and 940.003 nm.

13. The heterodyne imaging system of claim 9, wherein the illumination optical system is configured to provide flash illumination to illuminate all of the field of view simultaneously.

14. The heterodyne imaging system of claim 9, further comprising:
a memory for storing a succession of images generated by the heterodyne sensor; and
a post-processing circuit configured to perform a Fourier transform operation on the pixel values captured by each pixel in the succession of images in order to evaluate a frequency variation captured by each pixel, and to generate a depth value per pixel.

15. A method of capturing a depth image based on a heterodyne sensor, the method comprising:
combining, by one or more optical mixers, a reference light beam and one or more return light beams in order to generate one or more beat signals;
generating, by a single-photon avalanche diode of each pixel of a pixel array of the heterodyne sensor, an output signal as a function of a light intensity of a corresponding one of the one or more beat signals; and
generating, by a digital counter of each pixel, a count value based on the output signal of the single-photon avalanche diode.

16. The method of claim 15, wherein the array comprises pixels arranged in rows and columns, the method further comprising operating, by a sequencer of the heterodyne sensor, the pixels of the array in a rolling shutter operation wherein the counters of the pixels of each row of the array are read during a corresponding read phase that is offset with respect to the read phases of the counters of the pixels of the other rows of the array.

17. The method of claim 15, wherein a sampling frequency of the counter of each pixel is of less than 500 kHz, and preferable of less than 100 kHz.

18. The method of claim 15, further comprising:
generating, by a modulation circuit, a ramp signal for modulating a coherent light source in order to generate a modulated light beam;
splitting, by an optical splitter, the modulated light beam into said reference light beam and a transmission light beam; and
illuminating, by an illumination optical system, a field of view of the heterodyne sensor with the transmission light beam.

19. The method of claim 15, further comprising:
storing to a memory a succession of images generated by the heterodyne sensor; and
performing, by a post-processing circuit, a Fourier transform operation on the pixel values captured by each pixel in the succession of images in order to evaluate a frequency variation captured by each pixel, and thereby generate a depth value per pixel.

20. The method of claim 15, wherein illuminating the field of view comprises illuminating all of the field of view simultaneously with a flash from the illumination optical system.
